(19) United States
(12) Patent Application Publication
(10) Pub. No.: US 2016/0103426 A1
(43) Pub. Date: Apr. 14, 2016

(54) Clock

(71) Applicant: Fred Watts, Florissant, MO (US)

(72) Inventor: Fred Watts, Florissant, MO (US)

(21) Appl. No.: 14/512,432

(22) Filed: Oct. 12, 2014

(51) Int. Cl. G04G 9/00

(52) U.S. Cl. CPC G04G 9/0017

(57) ABSTRACT

An electronic clock operable to provide the time of day and further being configured to provide a visual effect. The clock includes a housing having a plurality of walls, top and bottom formed to create an interior volume. The clock includes a first display screen and a second display screen mounted into the housing. The first display screen provides the time of day and the second display screen is configured with a plurality of light emitting diodes organized into a lighting pattern that is operable to provide the visual effect of a conventional swinging pendulum. A control module is present so as to facilitate user control of the electronic clock. A central processing unit provides control of the clock and the clock further includes an audio output to emit sounds therefrom.

### FIELD OF THE INVENTION

The present invention relates generally to time-keeping pieces, more specifically but not by way of limitation, a clock having a first display screen and a second display screen wherein the second display screen is operable to provide a visual representation of a swing pendulum.

### BACKGROUND

Time keeping instruments such as watches and clocks have been utilized for centuries. Whether for ornamental appearances or for official time keeping of an event, various clocks and watches provide either the required functionality or the desired ornamental appearance of the user. Numerous types of clocks exist and can include desktop clock, wall clocks and clock that are floor-mounted models. One popular type of floor-mounted clock from years ago was the grandfather clock. As is known in the art, the grandfather clock was a large floor mounted clock that included a lower portion that was manufactured so as to provide visibility to the pendulum arm. Many users enjoyed the visual stimulation of the pendulum arm as well as the programmed sounds that conventional grandfather clocks produced at certain intervals.

It is desired within the scope of the present invention to provide a clock that is configured to be either floor mounted or desk mounted that adapts modern technology to provide a visual display of a pendulum arm and further integrates into current electronic devices to broadcast sounds and/or music files.

### SUMMARY OF THE INVENTION

It is the object of the present invention to provide a clock that includes a housing wherein the housing is either adapted for wall mounting, desk mounting or floor mounting that is operable to provide a visual display of time and a time keeping effect.

Another object of the present invention is to provide a clock that is operable to provide a visual display of time and a time-keeping effect wherein the housing of the clock includes a first display screen.

A further object of the present invention is to provide a clock that is operable to provide a time display and a visual effect display wherein the time display is projected with the first display screen.

An additional object of the present invention is to provide a clock being configured to provide a time display and a visual effect display wherein the housing further includes a second display screen.

Yet another object of the present invention is to provide a clock being configured to provide a time display and visual effect display wherein the visual effect display is delivered on the second display screen.

Still a further object of the present invention is to provide a clock operable to provide a visual of the time and a displayed visual effect wherein the visual effect is an electronic reproduction of a pendulum swing.

An alternative object of the present invention is to provide a clock having a first display and a second display configure to provide the time of day and a visual effect wherein the clock further includes a means to receive audio files such as but not limited to a USB port or wireless connection.

An added objective of the present invention is to provide a clock having a first display screen operable to provide a visual display of the time of day and a second display screen operable to provide a visual effect that includes a CPU to control the programming thereof.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front view of an embodiment of the present invention;

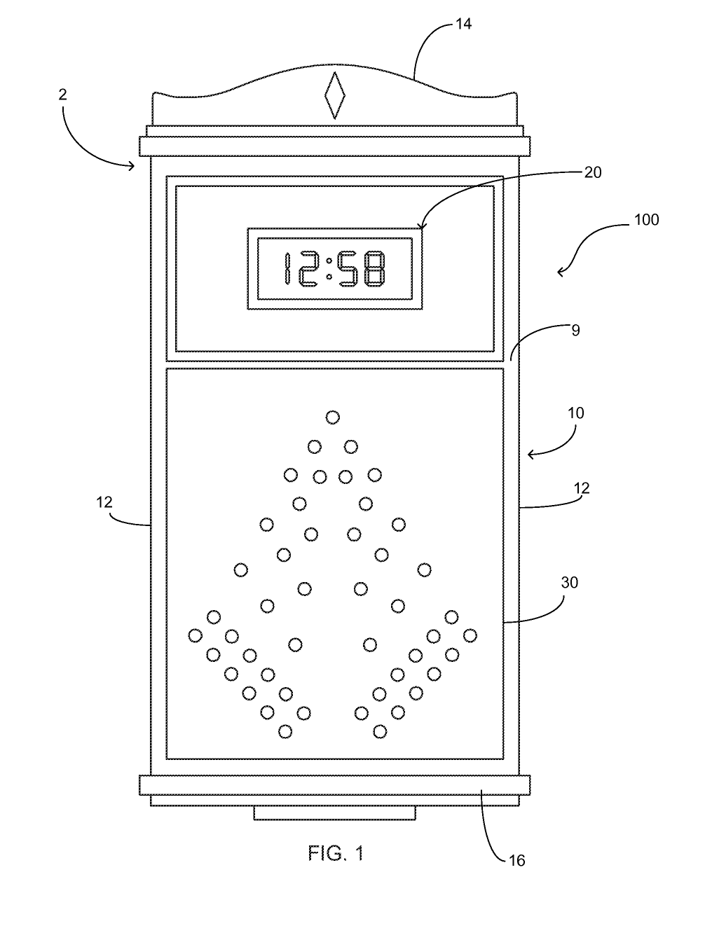

FIG. 2 is a schematic diagram of the light pattern of the second display screen; and

FIG. 3 is a block diagram of the components of the present invention.

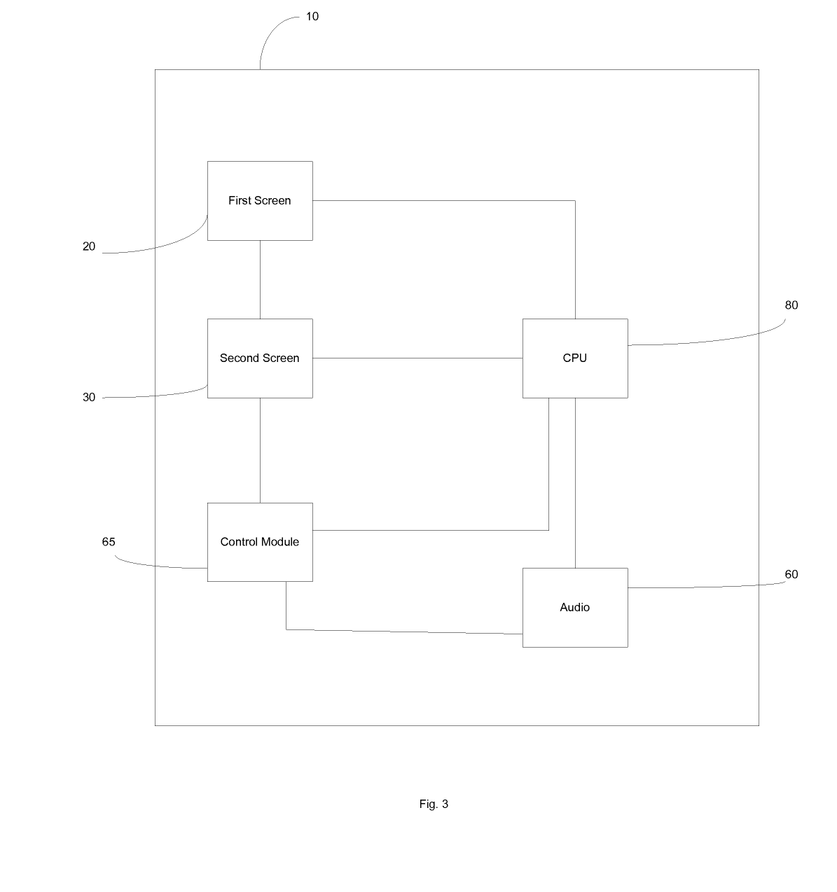

### DETAILED DESCRIPTION

Referring now to the drawings submitted herewith, wherein various elements depicted therein are not necessarily drawn to scale and wherein through the views and figures like elements are referenced with identical reference numerals, there is illustrated a clock 100 constructed according to the principles of the present invention.

The clock 100 further includes a housing 10 that includes a plurality of walls 12, top, 14 and bottom 16 formed to create an interior volume operable to receive components therein. The housing 10 is manufactured from a suitable durable material such as but not limited to wood or plastic. It is contemplated within the scope of the present invention that the housing 10 could be constructed in various different sizes. More specifically but not by way of limitation, it is contemplated within the scope of the present invention that the housing 10 could be constructed as a floor model clock or a wall mounted clock. It should be further recognized that the housing 10 could be formed with various ornamental structures in order to provide different embodiments thereof.

Secured within the front panel 9 of the housing 10 is the first display screen 20. The first display screen 20 is a conventional LCD screen that is operable to display the time of day by projecting numerical characters. The clock 100 includes a CPU 80 disposed within the housing 10 that includes the necessary electronics to store, receive, transmit and manipulate data. The first display screen 20 is operably coupled to the CPU 80 wherein the CPU 80 includes the functionality of timekeeping and is operable to provide a projected digital display of the time of day on the first display screen 20. The first display screen 20 is proximate the upper end 2 of the housing 10 and is manufactured of a suitable size. It is contemplated within the scope of the present invention that the first display screen 20 could be manufactured in various different sizes and shapes. It is further contemplated within the scope of the present invention that the first display screen 20 could project and analog image of the time of day in addition to and/or in conjunction with the digital numeric display of the time of day.

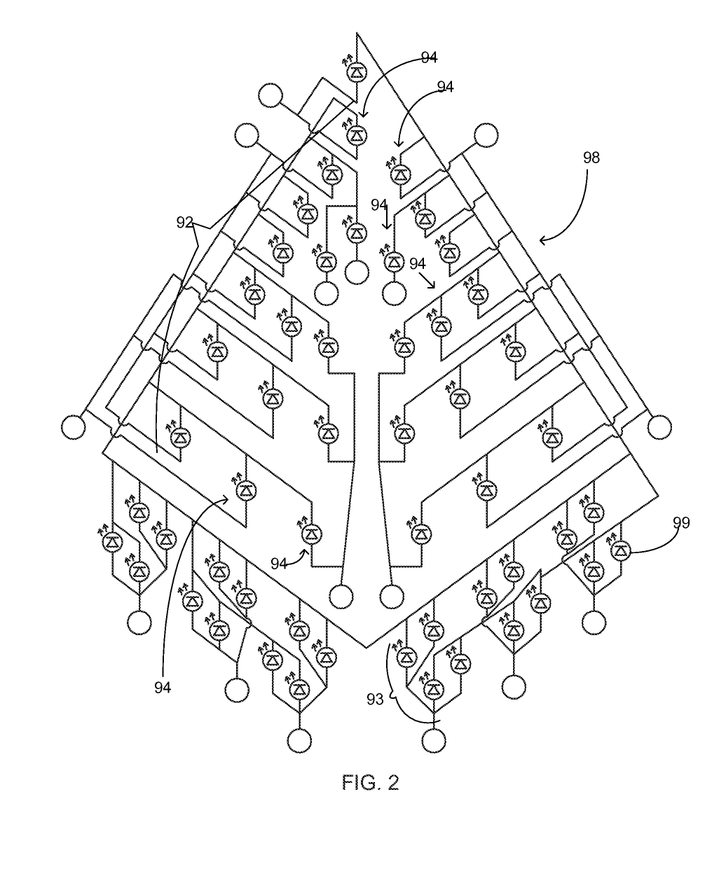

Secured within the front panel 9 of the housing 10 and underneath the first display screen 20 is the second display screen 30. The second display screen 30 is operable to display a visual effect. As shown in the schematic diagram in FIG. 2 submitted herewith, the second display screen 30 includes the necessary electronics operable to provide the visual effect of a swinging pendulum. The light pattern 98 of FIG. 2 comprises of a plurality of light emitting diodes 99 oriented in such a manner that subsequent the CPU 80 initiating the lighting sequence of the light pattern 98 a visual effect of a swinging pendulum is provided on the second display screen 30. The light pattern 98 includes a plurality of light emitting diodes 99 oriented in a first group 92 and a second group 93. The first group 98 of light emitting diodes 99 are oriented in a linear and adjacent manner so during the lighting sequence the first group 92 represents an arm of a swinging pendulum. Each row 94 of the first group 92 is adjacent each other and operable to be illuminated in sequential order thus projecting the visual effect of an arm portion of a conventional swinging pendulum. The second group 93 consists of a plurality of light emitting diodes 99 organized in a clustered pattern operable to visually represent a pendant of conventional swinging pendulum. As shown in particular in FIG. 2 herein, the light emitting diodes 99 within the second group 93 are organized in a diamond pattern so as to project a visual effect of a diamond shaped pendant. It is contemplated within the scope of the present invention that the light emitting diodes 99 of the second group 93 could be organized in numerous different shapes so as to provide visual representation of a pendant of different shapes. More specifically but not by way of limitation the light emitting diodes 99 of the second group 93 could be arranged in a circular or square pattern. The CPU 80 illuminates the second group 93 simultaneously with the first group 92 immediately thereabove. The second display screen 30 is approximately two-thirds the surface area size of the front panel 9 so as to provide a sufficient surface area for arranging a light pattern 98 operable to provide a visual effect. While good results have been achieved utilizing a second display screen 30 of the aforementioned surface area, it is contemplated within the scope of the present invention that the second display screen 30 could be configured to have various sizes of surface areas.

While the second display screen 30 is configured with light emitting diodes 99, it is contemplated within the scope of the present invention that the light pattern 98 could utilize various types of light emitting components. More specifically but not by way of limitation, the light pattern 98 could utilize fiber optic light strands or other types of low wattage light bulbs. Additionally, it is contemplated within the scope of the present invention that the second display screen 30 could be a LCD screen or an equivalent thereof. As discussed herein the second display screen 30 could be programmed to display various visual effects in addition to a conventional swinging pendulum. Utilization of a LCD screen for the second display screen 30 would provide alternative options in creating visual effects. It is further contemplated within the scope of the present invention that the second display screen 30 be programmed via the CPU 80 to provide more than one visual effect. For example but not by way of limitation, a user could program the second display screen 30 to provide a visual effect of fireworks on a holiday or birthday in addition to a swinging pendulum.

While the clock 100 has been disclosed herein as having a first display screen 20 and a second display screen 30, it is contemplated within the scope of the present invention to utilize one screen such as but not limited to a LCD screen to accomplish the stated objectives of the clock 100.

As previously discussed herein the CPU 80 includes the logic circuitry to control the operation of the light pattern 98 as discussed herein and provide the time to be displayed on the first display screen 20. The CPU 80 is further operably coupled to the audio unit 60. The audio unit 60 is a conventional sound producing device such as but not limited to a speaker. The audio unit 60 is programmable through utilization of the control module 65. The control module 65 provides a technique to enter data into the CPU 80 in order to provide control of the audio unit 60. More specifically but not by way of limitation the control module 80 in operable combination with the CPU 80 could be utilized to program the audio unit 60 such that the audio unit 60 emits sounds on the hour. It is contemplated within the scope of the present invention that the sounds emitted by the audio unit 60 could be a pre-recorded song or chime or be an audio data file that was loaded into the CPU 80 from an external device. It is further contemplated within the scope of the present invention that the control module 65 could be present as a first embodiment or a second embodiment.

In the first embodiment configuration, the control module 65 is a conventional control panel having input knobs, buttons and at least one USB port that are integrated into the housing 10 of the clock 100. This conventional style control module 65 would facilitate the selection of parameters such as but not limited too light intensity, the speed of the displayed swing pendulum and whether or not to emit an audio sound on the hour. Those skilled in the art will recognize that the first embodiment configuration of the control module 65 could provide numerous different controls over the lighting display and audio emitted. In an additional contemplated second embodiment the control module 65 is a software application loaded onto an electronic device such as but not limited to a tablet PC or smartphone. In this contemplated second embodiment, the control module is operably coupled to the CPU 80 and/or the control module 65 utilizing suitable techniques such as Bluetooth or other wireless communication protocols. In the contemplated second embodiment of the control module 65, the software application provides control over parameters such as but not limited to display of the light pattern 98, sounds and display of the time keeping on the first display screen 20. Utilization of a software application as the contemplated second embodiment provides advantages such as but not limited to facilitating the selection of a song(s) from a playlist to be emitted via the audio unit 60 at desired intervals. Further, the contemplated second embodiment provides remote access to the clock 100 wherein a user can access the clock 100 and control its functionality from remote locations. It should be noted that while not illustrated herein the clock 100 is powered by a conventional power source such as but not limited to a battery or 120V AC.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An electronic clock comprising:
a housing, said housing having a plurality of walls, bottom and top formed to create and interior volume, said housing having a front panel;
a central processing unit, said central processing unit having the necessary electronics operable to store, receive, transmit and manipulate data,
at least one screen, said at least one screen being secured within said front panel; and
wherein said at least one screen is operable to display the time of day and said second display screen is operable to provide at least one visual effect.

2. The electronic clock as recited in claim 1, further including a lighting pattern, said lighting pattern being displayed in said at least one screen.

3. The electronic clock as recited in claim 2, wherein said lighting pattern consists of a first group of lights and a second group of lights.

4. The electronic clock as recited in claim 3, wherein said first group of lights and said second group of lights are in general axial alignment and are operable to represent a conventional swinging pendulum.

5. The electronic clock as recited in claim 4, and further including a control module, said control module operable to provide a user interface to engage the electronic clock, said control module having a first embodiment and a second embodiment.

6. The electronic clock as recited in claim 5, wherein said second group of lights are arranged in a pattern selected from a group of the following: diamond, square or circular.

7. The electronic clock as recited in claim 6, further including an audio unit, said audio unit being operably coupled to said central processing unit and said control module, said audio unit being operable to emit sound.

8. An electronic clock operable to display the time of day and a visual effect comprising:
a housing, said housing consisting of a plurality of walls, top and bottom operable to form an interior volume having sufficient volume to receive components therein, said housing further including a front panel;
a first display screen, said first display screen being mounted within said front panel of said housing, said first display screen operable to display the time of day;
a second display screen, said second display screen being secured to said front panel of said housing, said second display screen being mounted underneath said first display screen on said front panel, said second display screen configured to display a visual effect;
a central processing unit, said central processing unit having the necessary electronics to store, receive, transmit and manipulate data, said central processing unit operably coupled to said first display screen and said second display screen;
a control module, said control module operably coupled to said central processing unit, said control module operable to facilitate user inputs to enter data into said central processing unit, said control module having a first embodiment and a second embodiment; and
wherein said second display screen is operable to display a plurality of visual effects thereon.

9. The electronic clock as recited in claim 8, wherein said second display screen includes a plurality of light emitting diodes comprising a lighting pattern, said lighting pattern having a first group of light emitting diodes and a second group of light emitting diodes.

10. The electronic clock as recited in claim 9, wherein said first group of light emitting diodes is organized in adjacent and linear rows so as to provide a visual display of an arm of a conventional swinging pendulum.

11. The electronic clock as recited in claim 10, wherein said second group of light emitting diodes of said lighting pattern is organized in a cluster so as to provide a visual display of a pendant of a conventional swinging pendulum.

12. The electronic clock as recited in claim 11, wherein during operation of said light pattern said first group of light emitting diodes and said second group of light emitting diodes are simultaneously and sequentially illuminated so as to provide a visual effect of a conventional swinging pendulum.

13. The electronic clock as recited in claim 12, wherein said second embodiment of said control module is a software application stored on a remote device that is operably connected to said central processing unit.

14. The electronic clock as recited in claim 13, and further including an audio unit, said audio unit operably coupled to said central processing unit, said audio unit operable to emit sound.

15. An electronic clock operable to display the time of day and a visual effect of a swinging pendulum comprising:
a housing, said housing consisting of a plurality of walls, top and bottom operable to form an interior volume having sufficient volume to receive components therein, said housing further including a front panel;
a first display screen, said first display screen being mounted within said front panel of said housing, said first display screen operable to display the time of day;
a second display screen, said second display screen being secured to said front panel of said housing, said second display screen being mounted underneath said first display screen on said front panel, said second display screen having a plurality of light emitting diodes organized into a lighting pattern, said lighting pattern consisting of a first group of light emitting diodes and a second group of light emitting diodes, said lighting pattern of said second display screen configured to display a visual effect of a conventional swinging pendulum;
a central processing unit, said central processing unit having the necessary electronics to store, receive, transmit and manipulate data, said central processing unit operably coupled to said first display screen and said second display screen; and
a control module, said control module operably coupled to said central processing unit, said control module operable to facilitate user inputs to enter data into said central processing unit, said control module having a first embodiment and a second embodiment, wherein said first embodiment of said control module consists of a control panel mounted to said housing wherein the control panel is configured to facilitate inputs by a user into said central processing unit.

16. The electronic clock as recited in claim 15, wherein said second embodiment of said control module is a software application stored on a remote device that is operably connected to said central processing unit, said second embodiment of said control module being operable to facilitate user control of the electronic clock.

17. The electronic clock as recited in claim 16, wherein said first group of light emitting diodes is configured in adjacent linear rows and is operable to provide a visual representation of a conventional arm of a swinging pendulum.

18. The electronic clock as recited in claim 17, wherein said second group of light emitting diodes of said lighting pattern is organized in a cluster so as to provide a visual display of a pendant of a conventional swinging pendulum.

19. The electronic clock as recited in claim 18, and further including an audio unit, said audio unit operably coupled to said central processing unit, said audio unit operable to emit sound.

20. The electronic clock as recited in claim 19, wherein said housing is provided in various sizes selected from a group consisting of: wall mounted or floor model.
